(19) United States
(12) Patent Application Publication
(10) Pub. No.: US 2005/0169238 A1
(43) Pub. Date: Aug. 4, 2005

(54) Obtaining routing information

(75) Inventors: Fan Yang, Helsinki (FI); Jian J. Ma, Beijing (CN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/795,251

(22) Filed: Mar. 9, 2004

(30) Foreign Application Priority Data
Jan. 30, 2004 (FI) 20040149

(51) Int. Cl. H04L 12/28

(52) U.S. Cl. 370/351

(57) ABSTRACT

A method for obtaining routing information relating to a routing path from a source node to a destination node among a set of nodes is discussed. The method comprises a step of sending a routing request from a current node, said routing request comprising information relating to a destination node location. At least one routing response is received in the current node, a routing response comprising information relating to a distance between a sender of the respective routing response and the destination node. A next node along the routing path is selected based at least on said distance between a sender of a routing response and the destination node. A node for an Ad Hoc network is also discussed.

### BACKGROUND OF THE INVENTION

1. Field of the Invention

The present invention relates to obtaining routing information. In particular, the present invention relates to obtaining routing information in Ad Hoc networks.

2. Description of the Related Art

A communication system can be seen as a facility that enables communication sessions between two or more entities such as user equipment and/or other nodes associated with the communication system. The communication may comprise, for example, communication of voice, data, multimedia and so on. Communication systems providing wireless communication for user equipment are known. Examples of traditional wireless communications systems, where the wireless communication system has a fixed infrastructure, are a public land mobile network (PLMN) a wireless local area network (WLAN).

Communication systems without a fixed infrastructure are also known. Usually these communications systems are called Ad Hoc networks. In Ad Hoc networks a set of nodes forming the Ad Hoc network can usually communicate without the presence of any specific infrastructure. New nodes can enter an Ad Hoc network, and current nodes can leave the Ad Hoc network. This means that in an Ad Hoc network the number and identity of nodes forming the Ad Hoc network changes dynamically. This is usually referred to as dynamically changing membership. Furthermore, the locations of the nodes may change. The topology of the Ad Hoc network may thus also change dynamically.

Due to the dynamically changing membership and the dynamically changing topology, node addressing in Ad Hoc networks and routing in Ad Hoc networks very relevant. A node should have an identifier (address), which is unique at least within the Ad Hoc network where the node is a member. As one solution, use of globally unique identifiers has been proposed. However, globally unique addressing schemes have disadvantages. One of them is that the identity of a node can be determined from the node address.

Random addressing in Ad Hoc networks has been proposed, for example, by S. Toner and D. O'Mahony in “Self-Organising Node Address Management in Ad-Hoc networks”, available at http://www.cs.tcd.ie/omahony/venice.pdf. The proposal is a scheme, where one of the nodes in an Ad Hoc network is elected as a leader node. The leader node hands addresses/identities to other nodes and updates a list of the nodes forming the Ad Hoc network.

Regarding routing in Ad Hoc networks, many proposed routing schemes use traditional routing algorithms. In traditional routing algorithms, a routing table is built which records at least all directly reachable nodes for each node. In order to keep contact with the neighboring nodes, a node has to send regularly refresh messages, usually called HELLO messages. For a mobile node, sending these refresh messages may consume a considerable amount of power. The life of a battery may thus be a problem.

Many basic route discovery algorithms are based on flooding. Route discovery based on flooding is illustrated in FIG. 1. When a source node S needs to discover a route to a destination node D, the source node S sends a route request identifying the destination node to all its neighbors, for example by broadcast. FIG. 1 shows that the route request from the source node S is sent of nodes A, B and C. If a node receiving a route request is not itself the destination node, it will forward the routing request to its neighbors. Before forwarding, a node typically adds its address or identifier to the route request. In FIG. 1, it is shown how nodes B, C and X forward route request to their neighbors. A node typically forwards only a first received route request relating to a given route discovery. In FIG. 1, the node X typically ignores one of the route requests it receives from nodes B and C. On receiving the route request, the destination node D sends a route reply to the sender of the route request. The route reply contains information indicating the path discovered from the source node S to the destination node D. The route reply is forwarded to the source node S along this path.

There are proposals for routing in Ad Hoc networks, where location of the nodes is used for route finding. One example is by Y-B. Ko and N. H. Vaidya, “Location-Aided Routing (LAR) in Mobile Ad Hoc networks”, in Proceedings of the 4th annual ACM/IEEE international conference on Mobile computing and networking, 1998, pp. 66 -75. In this proposal, the source node S determines an expected zone for the destination node based on a known location of the destination node D at a previous time. The source node S, furthermore, determines implicitly or explicitly a request zone. The request zone is a geographical zone within which route requests are sent. This means that route requests are forwarded only by nodes, which are located within the request zone.

One of the location-aided routing schemes proposed by Y-B. Ko and N. H. Vaidya is the following. It is assumed that the source node S knows the location (X_{D}, Y_{D}) of the destination node D at a time t₀. The route discovery is initiated at time t₁>t₀. The source node S calculates its distance D_{S} from the location (X_{D}, Y_{D}) and includes this distance to a route request. The coordinates (X_{D}, Y_{D}) are also included in the route request. When a node i receives the route request, it calculates its distance D_{I} from the location (X_{D}, Y_{D}). If D_{S}+δ≧Dᵢ, the node I forwards the route request to its neighboring nodes. The node I replaces D_{S} in the route request by Dᵢ in the route request before forwarding the route request. Otherwise, the node i discards the route request. The next node j receiving the route request containing Dᵢ acts similarly as the node i upon receiving the route request containing D_{S}. The parameter δ may be zero or larger than zero. In this location-aided routing scheme the route request is thus forwarded if the node receiving the route request is at most δ farther from the location (X_{D}, Y_{D}) than the sender of the received routing request.

The above discussed location-aided routing scheme assumes that the source node S has some information about the location of the destination node D. This may not always be true, and the location-aided routing scheme may not be applicable.

Y-B. Ko and N. H. Vaidya mention also a Metricom network in the above mentioned publication. Metricom is a packet radio system using location information for routing purpose. Metricom network infrastructure consists of fixed base stations whose precise location is determined at the time of installation. The fixed base stations collect location information of users (mobile nodes). In the case of Ad Hoc network, when a first user wants to call a second user, the first user may first contact a fixed base station to find the location of the destination. The first and second user then they set up a routing path through the Ad Hoc network. In order to let the fixed base station know the location of a mobile node, the mobile node has to regularly send HELLO messages to report its new location. This will cause a great amount of battery consumption in mobile.

There are thus problems relating to obtaining routing information and to addressing of nodes in Ad Hoc networks. It is appreciated that similar problems may exists also in other networks than Ad Hoc network.

Embodiments of the present invention aim to provide a feasible solution for obtaining routing information among a set of nodes.

### SUMMARY OF THE INVENTION

A first aspect of the present invention provides a method for obtaining routing information relating to a routing path from a source node to a destination node among a set of nodes, said method comprising

sending a routing request from a current node, said routing request comprising information relating to destination node location,

receiving at least one routing response in the current node, a routing response comprising information relating to a distance between a sender of the respective routing response and the destination node, and

selecting in the current node a next node along the routing path based at least on said distance between a sender of a routing response and the destination node.

A second aspect of the present invention provides a method for obtaining routing information relating to a routing path from a source node to a destination node among a set of nodes, comprising

receiving a routing request in a current node from a previous node, said routing request comprising information relating to a destination node location, and

sending a routing response, in response to receiving the routing request, to the previous node for selecting a next node along the routing path in the previous node, said routing response comprising information relating to a distance between the current node and the destination node location.

A third aspect of the present invention provides a node for network formed of a set of nodes, the node comprising routing means configured to

send a routing request comprising information indicating at least identifier of a destination node and destination node location,

receive at least one routing response, a routing response comprising information relating to a distance between a sender of the respective routing response and the destination node, and

select a next node along the routing path based at least on said distance between a sender of a routing response and the destination node.

A fourth aspect of the present invention provides for network formed of a set of nodes, the node comprising routing means configured to

receive a routing request comprising information relating to a destination node location, and

send a routing response for selecting a next node along the routing path, said routing response comprising information relating to a distance between the node and the destination node location.

### BRIEF DESCRIPTION OF THE DRAWINGS

Embodiments of the present invention will now be described by way of example only with reference to the accompanying drawings, in which:

FIG. 1 shows schematically a known routing discovery based on flooding;

FIG. 2 shows, as an example, a flowchart of a method 200 relating to initiating a route discovery algorithm in a source node in accordance with the first embodiment of the invention;

FIG. 3 shows, as an example, a flowchart of a method 300 relating to a route discovery algorithm in a current node in accordance with the first embodiment of the invention;

FIG. 4 shows schematically how a route discovery in accordance with a first embodiment of the invention proceeds in an Ad Hoc network from the source node S to the destination node D;

FIG. 5 shows schematically an example of an Ad Hoc network and routing discovery in accordance with a second embodiment of the invention and a separate communication network;

FIG. 6 shows schematically the exchange of location information via a separate communication network in accordance with the second embodiment of the invention;

FIG. 7 shows schematically an example of the format of the piece of information received from the destination node D over a separate communication system;

FIG. 8 shows schematically in more detail the format of the location information;

FIG. 9 shows examples of routing request and routing response messages;

FIG. 10 shows further examples of routing request and routing response messages;

FIG. 11 shows an example of a data packet header format, the data packet being sent from the source node S; and

FIG. 12 shows schematically a block diagram of a node for an Ad Hoc network in accordance with an embodiment of the present invention.

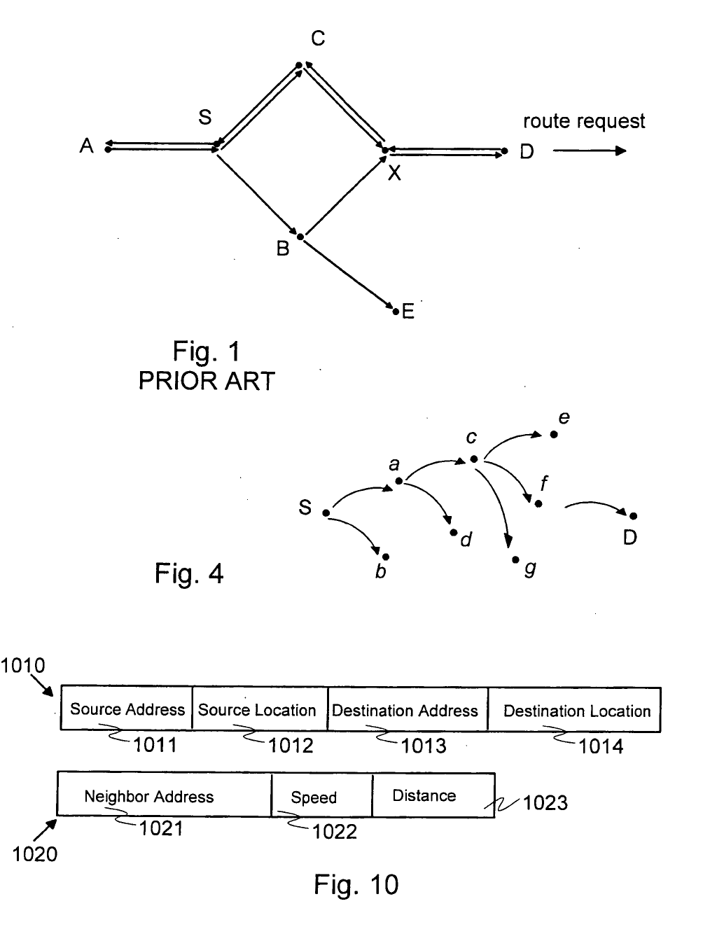

### DETAILED DESCRIPTION OF THE PREFERRED EMBODIMENTS

In the following description, reference is often made to a set of nodes forming an Ad Hoc network. It is, however, appreciated that the invention may be applicable to any set of nodes forming a network or a part of a network.

The term node refers here to a communications device capable of communicating with other communications devices. A node may be fixed or mobile.

In the following description a node selected to form part of the routing path are denoted with Nₖ, where the subindex k>0 refers to the routing hop. A node receiving a routing request is denoted with n_{k,i}. The first subindex k refers to the routing hop, and the second subindex i refers to each node receiving a routing request sent by node Nₖ₋₁.

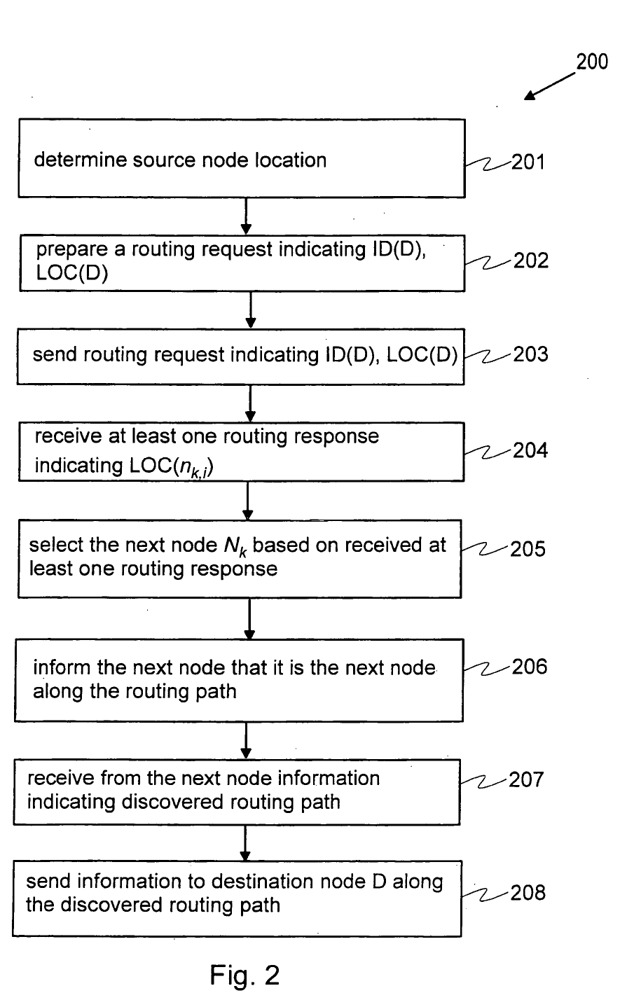

A first embodiment of the invention focuses on route discovery, and it is assumed here that the source node S has determined the location of the destination node D or an estimation for the location of the destination node D. FIG. 2 shows, as an example, a flowchart of a method 200 relating to a route discovery algorithm in accordance with the first embodiment of the invention. This method 200 is carried out in the source node S initiating the route discovery.

In step 201 a source node S determines its own location, if it does not already know the location or if the location may have changed since the last determination. The location may be determined using, for example, a satellite positioning system such as the Global Positioning System (GPS). As a further example, if the node has functionality for communicating with a cellular communications network, the location may be determined using positioning methods supported by the cellular communications network. Thereafter in step 202 the source node S prepares a routing request indicating typically at least identifier of the destination node ID(D) and the destination node location LOC(D). Typically the routing request indicates also a distance between the source node location and the destination node location DIST(S,D). The routing request may indicate either the locations of both the source node S and the destination node D, or the location of the destination node D and the distance between the source node S and the destination node D. Typically the routing request indicates also the identifier of the source node S. As is evident to one skilled in the art, a routing request often contains also an identifier of the route discovery instance, for distinguishing routing requests relating to this specific route discovery instance from other routing requests.

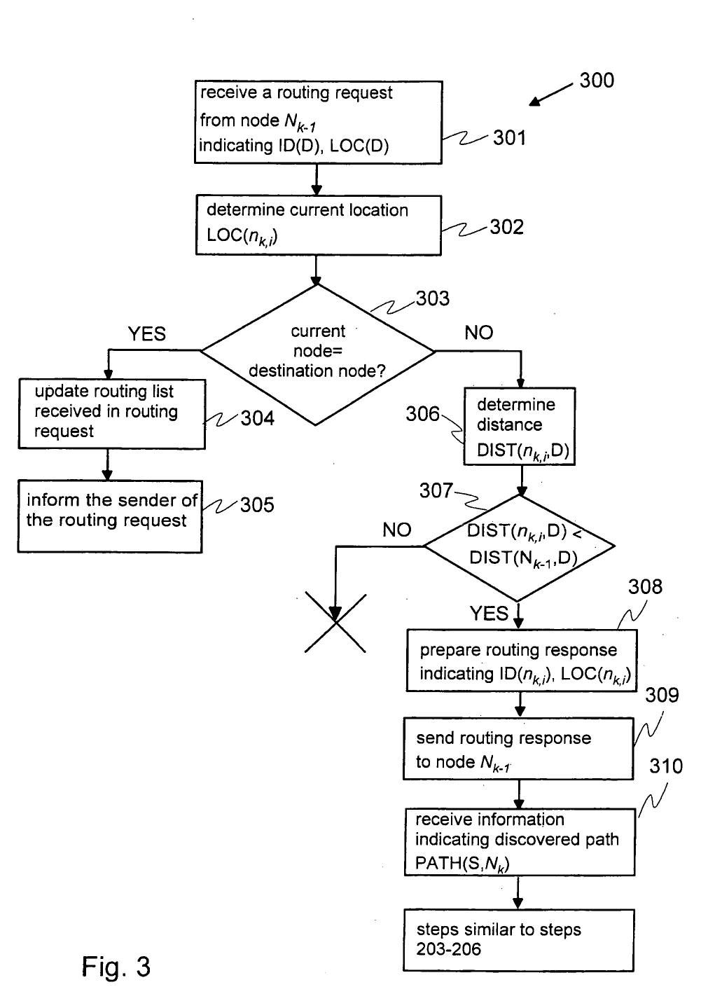

In step 203 the source node S sends the routing request indicating at least ID(D) and LOC(D). Typically the routing request is broadcast, and all nodes n_{k,i} receiving the routing request process it (details are discussed below in connection with FIG. 3). Typically at least nodes closer to the destination node that the source node send routing responses to the source node. In step 204 the source node receives at least one routing response. In step 205 the source node S selects based on the received routing responses one of the nodes n_{k,i} sending a routing responses to be the first node N₁ in the routing path.

A routing response indicates typically at least the identity of the responding node ID(n_{k,i}) and distance between the responding node and the destination node DIST(n_{k,i}, D). The distance between the responding node and the destination node may be indicated explicitly. Alternatively, the routing response may indicate the location of the responding node LOC(n_{k,i}) instead of DIST(n_{k,i}, D). The selection of the first node N₁, may be done based on the distances DIST(n_{k,i}, D), so that the node having the smallest distance to the destination node is selected as the next node along the routing path. Alternatively, it is possible that a routing response indicates also a velocity of the responding node n_{k,i}. In this case it is possible, for example, to define a threshold which the velocity of a node should not exceed. This is because a fast moving node may mean that the routing path will need to be updated quite soon.

In step 206 the source node S sends to the selected next node information indicating that it is the next node in the routing path. Typically the information is a routing list containing the identifier of the source node. Thereafter the source node S waits for information indicating a discovered path PATH(S, N₁, N₂, . . . , Nₖ, D) from the source node S to the destination node D. This information is typically a routing list containing the identifiers of the nodes in the order determined by the discovered routing path. In step 207 the source node S receives information indicating the discovered routing path. Thereafter the source node S may send information along the discovered routing path to the destination node D in step 208.

FIG. 3 shows, as an example, a flowchart of a method 300 relating to a route discovery algorithm in accordance with the first embodiment of the invention. This method 300 is carried out in a node receiving a routing request, below called a current node n_{k,i}.

In step 301 the current node receives a routing request. In step 302 the current node determines its location LOC(n_{k,i}), if it does not know the location already or if the location may have changed since the last determination. In step 303 the current node firstly determines whether it is the destination node, by comparing the identifier of the destination node ID(D) in the received routing request to its own identifier ID(n_{k,i}). If the current node is the destination node, the current node typically updates in step 304 the routing list received in the routing message to contain its identifier. Thereafter the current node sends in step 305 information indicating that it is the destination node to the sender of the routing request. Typically the information sent in step 305 indicates the discovered routing path between the source node S and the destination node D. In other words, the information contains a completed routing list.

If the current node receiving the routing request is not the destination node, the method 300 continues from step 306. It is appreciated, however, that step 306 and 307 are optional, and the method 300 may continue directly from step 308. In step 306 the current node determines the distance DIST(n_{k,i},D) between its location and the location of the destination node D. The location of the destination node is indicated in the routing request. In step 307 the distance DIST(n_{k,i},D) between this node and the destination node is compared with the distance DIST(Nₖ₋₁,D) between the sender of the routing request and the destination node D. The distance DIST(Nₖ₋₁,D) is indicated in the routing request, either explicitly or implicitly. If steps 306 and 307 are present in the method 300, a routing response may be prepared in step 308 and sent in step 309 only if the current node is closer to the destination node than the sender of the routing request. Alternatively, it is possible that a routing response is always prepared and sent by the current node in response to a received routing request. The routing response indicates at least the identity of the current node ID(n_{k,i}) and the distance between the current node and the destination node DIST (n_{k,i},D) Alternatively, the routing response may indicate the location of the responding node LOC(n_{k,i}) instead of DIST(n_{k,i}, D).

The method 300 continues from step 310 onwards, if the previous node along the routing path selects the current node as the next node along the routing path. In that case, the current node receives in step 310 information indicating that it is the next node along the routing path. Thereafter the method 300 continues with steps similar to steps 203-207. The difference is that in step 203-207 reference is made to node N₁, whereas in the method 300 the node Nₖ is selected and informed of the selection. Upon successfully discovering a route to the destination node D, the current node receives at some point information indicating a discovered routing path from the source node S to the destination node D. It forwards information indicating the discovered routing path to the previous node along the routing path, and this way the discovered routing path information reaches the source node S. The information indicating the discovered routing path is typically a completed routing list.

FIG. 4 shows an example of a route discovery procedure in accordance with the first embodiment of the invention. The source node S broadcasts a routing request, which is received by nodes a and b. Nodes a and b send to the source node S routing responses. The source node S selects the node a as the next node N₁, along the routing path. Thereafter the node a is informed of the selection with message PATH(S,a), and the node a broadcasts a routing request. Nodes c and d receive this routing request and provide routing responses to node a. Node c is, in turn, selected to be the next node N₂. Node c then sends a routing request, which is received by nodes e, f and g. Of these nodes, node f is, in turn, selected to be the next node N₃. The route discovery proceeds then to the destination node D.

It is appreciated that only the node Nₖ of the nodes n_{k,i} forwards the routing request. This means that the other nodes n_{k,i} need not be involved further in the path discovery procedure. As at each hop the previous node selects the next node before the routing request is forwarded, routing requests are broadcast only along the routing path to be discovered. This saves communication resources in the Ad Hoc network and also consumes less power in the nodes than a route discovery algorithm based on flooding, where each node forwards a received routing request. Also a traditional routing table indicating at least nearest nodes can be omitted, and this reduces consumption of battery even further.

It is appreciated that the location of a node is typically indicated using latitude and longitude coordinates. Any other suitable coordinate system may, however, alternatively be used.

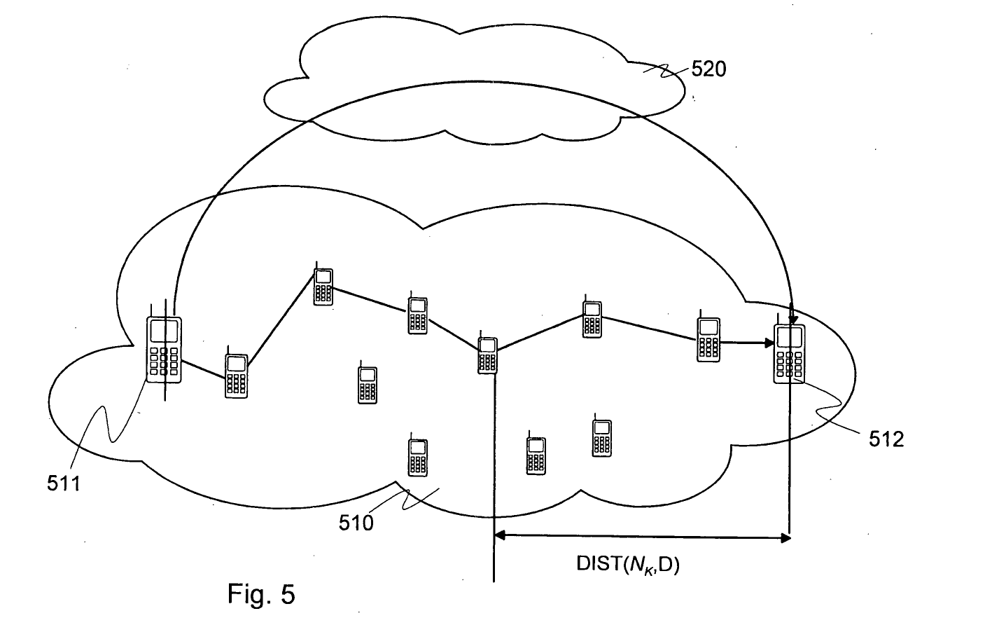

In a second embodiment of the invention, the source node S receives information about the location of the destination node D by communicating with the destination node D via a communication system separated from the Ad Hoc network. If the identity of the destination node D within the Ad Hoc network is not known to the source node, the source node may receive information about the destination node's identity/address with respect to the Ad Hoc network via the communication system from the destination node. It is alternatively possible that, for example, from knowing the destination node's telephone number or other identity with respect to the communication system, it is possible for the source node to determine the destination node's Ad Hoc network identity/address. This may be done, for example, by querying a directory or using a predefined rule defining a relationship between an Ad Hoc network address/identity and a telephone number. The separate communication system may be a cellular communication system, as shown in FIG. 5.

FIG. 5 shows an Ad Hoc network 510. The Ad Hoc network 510 is formed of mobile stations, although for the second embodiment only the source node S 511 and the destination node D 512 need to be mobile stations. The term mobile station here refers to any communication device capable of communications via the cellular communication system 520. The nodes of the Ad Hoc network 510 need to be able to determine their locations for being able to participate in the route discovery procedure, which employs location information.

The source node 511 communicates with the destination node 512 through the cellular communication system 520. The source node 511 and the destination node 512 exchange Ad hoc network identifiers and geographical location information before user data transfer in the Ad Hoc network 510. For the purposes of finding a route from the source node S to the destination node D, it is sufficient that the source node S receives information indicating the location of the destination node and, possibly, indicating also an identifier for the destination node. For further purposes, for example, for charging, both the source node S and the destination node D may need information about the other node's identity and/or location. The geographical location information may be determined, for example, with the help of GPS or other positioning system.

After exchanging location information via the cellular communication system, the source node 511 initiates a route discovery procedure in the Ad Hoc network 510. FIG. 5 shows an example of a discovered route between the source node 511 and the destination node 512.

Each node of the Ad Hoc network 510 is able to determine its location, for example by having GPS functionality. Using the routing requests and responses the nodes can identify their distances to their neighbors (at least to those from whom they receive routing responses) and to the destination node. The routing is based on minimal/optimal reachable distance. As discussed above in connection with the first embodiment of the invention, the route discovery proceeds closer to destination. In the other words, it is straightforward to judge the next routing hop (the next node). Instead maintaining a conventional routing table, a node may dynamically enquire its neighbors by broadcasting when and only when it wants to establish a routing path to a destination node. With such a routing strategy, not only routing complexity can be largely reduced, but also a traditional routing table can be omitted and thus, the consumption of battery can be reduced. Meanwhile, the reliability of data routing in the Ad Hoc network 510 is enhanced in a high degree.

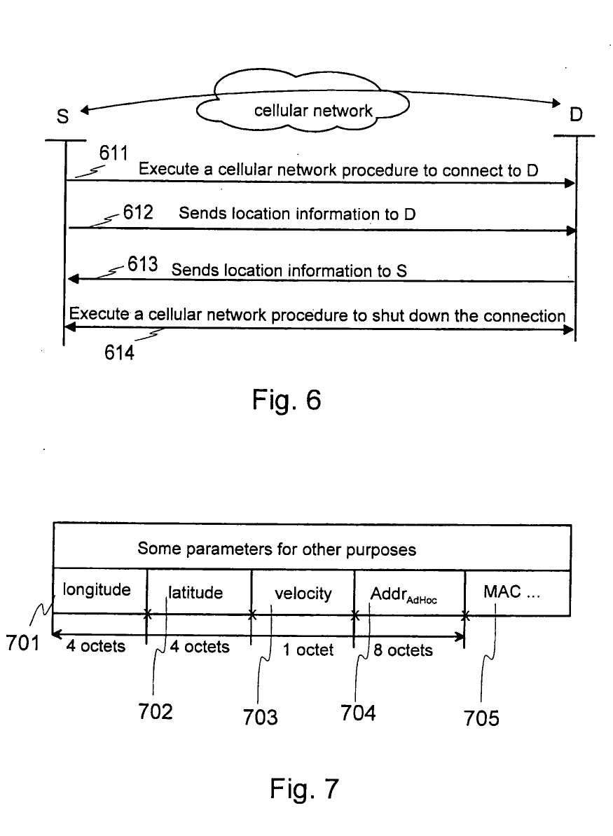

FIG. 6 shows schematically the exchange of location information via a separate communication network, in FIG. 6 the cellular communication system 520. The source node S connects to the destination node D through the cellular communication system 520 (arrow 611 in FIG. 6). Then the source node S exchanges location information and possibly also identity information with the destination node D (arrows 612 and 613). After that the source node S and the destination node D typically execute a cellular network's procedure to shut down the connection. The connection between the source node S and the destination node D may be a circuit-switched or a packet-switched connection. As an example, the connection may use circuit-switched data in the Global System for Mobile communications (GSM) or it may use General Packet Radio Service (GPRS).

FIGS. 7 and 8 show schematically an example of the format of the piece of information received from the destination node D over the cellular communication system 520. The piece of information may consist of four fields: longitude 701, latitude 702, velocity 703 and Ad Hoc network address 704. The Ad Hoc network address may be dynamically generated in accordance with a random seed maintained in the mobile node when the mobile node joins in the Ad Hoc network. Thus, eavesdroppers cannot trace connection because the addresses of source and destination can be changed from time to time. The Ad Hoc network address 704 functions as an identifier of a node in the Ad Hoc network for a certain period of time. The velocity 703 is not essential for the routing purposes, but it may be helpful for discarding nodes moving too fast for enabling a routing path to be valid for a longer period of time. The velocity information may also be needed, for example, for charging. If the source node and/or the destination node is too fast, then it is very easy to lose their connection in the Ad Hoc network. As FIG. 7 and FIG. 8 in more detail show, both the longitude 701 and the latitude 702 may be 32-bit unsigned integer variables. The leftmost bit 801 may indicate east (1) or west (0) in longitude and north (1) or south (0) in latitude. The next nine bits 802 may be used to record degrees (0°-360°) and the rest of the bits 803 are for decimals. The velocity 703 can be one octet, and its unit may be meter per second. The velocity may be used to judge the reliability of connection. The address 704 is the Ad Hoc network address to identify the node within the Ad Hoc network 510. It is furthermore possible to generate a message authentication code (MAC) 705, for example using the MD5, to verify the exchanged data. It is appreciated that some parameters for other purposes (e.g., security setup) may share the same connection as the location query.

It is evident for one skilled in the art that other encoding systems than the one shown in FIGS. 7 and 8 may alternatively be used. In the second embodiment of the invention, if the Ad Hoc network address of the destination node D is known to the source node S, it is sufficient for the source node S to receive the location of the destination node D over the cellular communications network 520.

In a third embodiment of the invention, the source node S receives from the destination node D information indicating at least the location of the destination node D and the Ad Hoc network address of the destination node D. As discussed above, the source node S and the destination node D may exchange also further information over the cellular communication network 520.

In the third embodiment of the invention, a node of the Ad Hoc network may generate its Ad Hoc network addresses independently. This feature is useful, for example, for hiding all the private parameters (including MSISDN number). Furthermore, it is advantageous that there is no need to manage the Ad Hoc network addresses. The Ad Hoc network address of a node may be changed across rebooting or manually. The length of an Ad Hoc address may be, as a typical example, 64 bits.

In general, an Ad Hoc address can be generated by Addr=G_{A}(base_number). Usually, function G_{A} can be based on some hash function and base_number may consist of some pseudorandom numbers. It is appreciated that both function G_{A} and base_number can be private, that is known only to the node. This means that each node of the Ad Hoc network can use its own G_{A} function and base_number to generate an Ad Hoc address.

As an example of generation of Ad Hoc address, below is an extract of a procedure relating to Ad Hoc network address generation.

base_number:

srandom(seed);

base_number=random64( );

G_{A}:

addr=(MD5(base_number) mod 2⁶⁴) xor ((MD5(base_number)>>64) mod 2⁶⁴)

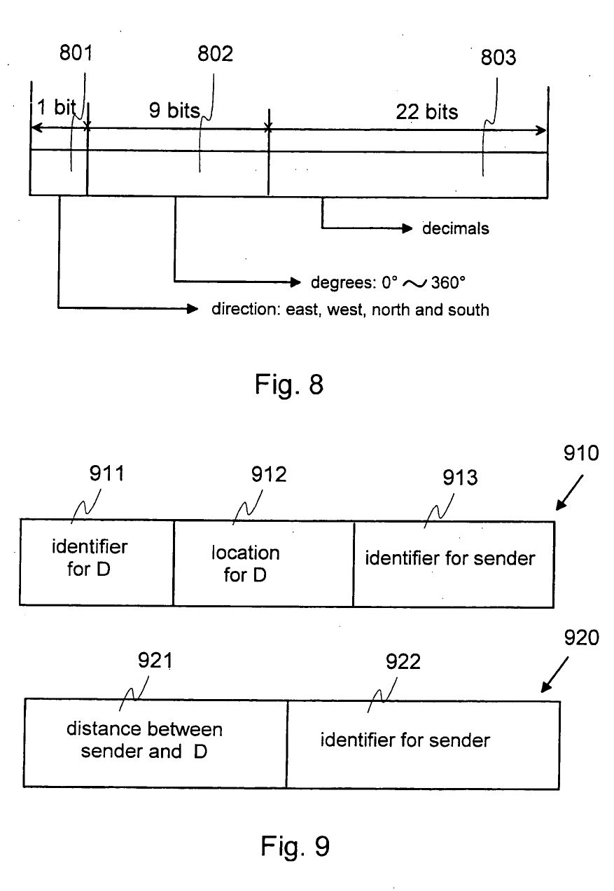

FIG. 9 shows examples of routing request 910 and routing response 920 messages. As discussed above, the routing request contains information indicating the identity of the destination node D in the Ad Hoc network (in other words, the Ad Hoc network address of the destination node) and the location of the destination node D. The routing request message 910 contains an identifier 911 for the destination node and a piece of information 912 indicating the location of the destination node. The piece of information 912 may contain information in the format shown in FIG. 8. Furthermore, as the routing request is typically broadcast it may contain also information indicating the sender of the routing request. The routing message 910, for example, contains a further identifier 913 indicating the sender of the routing message 910.

As discussed above, a routing response contains information indicating at least the distance between the sender of the routing response and the destination node. The routing response message 920 contains a piece of information 921 indicating the distance between the sender of the routing response and the destination node Alternatively, the piece of information 921 may indicate the location of the sender of the routing response, as the node requesting routing information already knows the location of the destination node. Typically, the routing request also contains information indicating the identity of the sender of the routing request in the Ad Hoc network. The routing response message 920 contains an identifier 922 identifying the sender of the routing response message 920.

If in the route discovery algorithm only nodes nearer to the destination node than the sender of a routing request provide routing responses, the routing request indicates also the distance between the sender Nₖ₋₁ of the routing request and the destination node D. This can be indicated, for example, by having in the routing response a piece of information defining this distance. Alternatively, a routing request may contain information indicating the location of the sender Nₖ₋₁ of the routing request. A node nₖ receiving the routing request is able to determine the distance between the destination node D and the previous node Nₖ₋₁ in the routing path from the two pieces of location information present in the routing request.

FIG. 10 shows a second example of routing request 1010 and routing response 1020 messages. The routing request message 1010 contains a first identifier (Source Address) 1011 identifying the source node, a first piece of location information (Source Location) 1012 for the source node, a second identifier (Destination Address) 1013 identifying the source node, and a second piece of location information (Destination location) 1014 for the destination node. The routing response message 1020 contains an identifier (Neighbor Address) 1021 identifying the sender of the routing response message, a piece of information 1022 indicating the velocity of the sender, and a piece of information 1023 indicating the distance between the sender of the routing response message and the destination node.

As the velocity of the sender is present in the routing response message 1023, the node Nₖ₋₁ may use this information is selecting the next node Nₖ. As mentioned above, a threshold value may be set for the velocity. As an example, the threshold may be about 3 m/s (that is, about 10 km/h). If the velocity indicated in a routing response is higher than the threshold value, the routing response is ignored. This is because otherwise the maintenance of routing path may need to be done on a very frequent basis.

The information indicating the discovered routing path, which is sent from the previous node Nₖ₋₁ to the next node Nₖ, may be simply a sequence of identifiers for the nodes. Each selected node may update the information indicating the discovered routing path received from the previous node. Another alternative is that the previous node updates the information indicating the discovered routing path before sending it to the next node. When the routing discovery reaches the destination node D, the information indicating the complete discovered routing path PATH(S, N₁, N₂, . . . , Nₖ, D) is sent back to the source node S along the discovered routing path.

It is noted that it is possible that a routing path cannot be established. For example, because of a complicated topology of an Ad Hoc network, the routing request starting from the source node S may never reach the destination node D. Alternatively, the information indicating the complete discovered routing path may never reach the source node S. To solve this question, two options are presented here. The first option is that after receiving the location information of the destination node, for example over the separate communication system, the source node S may calculate the distance between the source node S and the destination node D. If the source node S finds the distance is larger than some threshold value, the source node S may give a warning to user of the source node device to indicate a considerable probability of connection failure. Thus, if the user does not want to take risk for the Ad Hoc connection, he/she may save some battery. A second option is that the source node S sets a timer T after it sends a routing list to the selected fist node (or other information indicating that the receiver has been selected as the first node). If the timer T expires and the source node S does not receive a completed routing list, the source node may try another time the establishment of the routing path. It is appreciated that in this case, the source node should start from determining the location of the destination node and not simply initiate another routing discovery procedure. As an example, after trying three times the establishment of routing path without success, the source node may give up the attempt and return error information to user.

During data transmission, both the source node S and the destination node D may set a timer t₁. When the timer t₁ expires, an indication message may be sent over the Ad Hoc network to the other node to tell new location. Thereafter one of the nodes may initiate the routing discovery procedure. It is noted that it is unnecessary to synchronize the timer t₁ for the source and destination nodes. The indication message may have, for example, the same format as is shown in FIG. 7.

After a routing path is established, one may still need to frequently maintain the path in an Ad Hoc network. In order to do so, the source node S may set a timer t₂. When the timer t₂ expires, the source node initiates the routing discovery procedure for discovering a new routing path. This routing discovery procedure is typically initiated using location information of the destination node D available in the source node S. Before the new routing path is established, the original path may be kept to transmit data in the Ad Hoc network. It is noted that the timer t₂ should generally be larger than t₁. If the timer t₂ is too large, the changes of Ad Hoc network topology may be considerable and the established path may become ineffective.

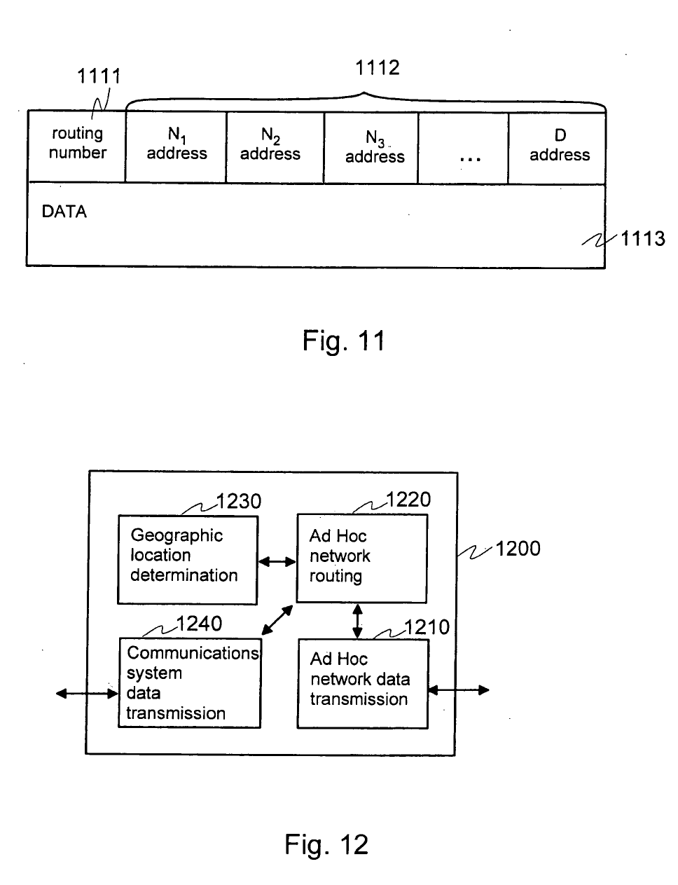

After a routing path is established, both the source node S and the destination node D may start to transmit data over the Ad Hoc network. In order to simplify data routing in the middle nodes, a sender of a data packet (that is, the source node S or the destination node D) may insert the routing list in the header of data packets. FIG. 11 shows one example of a data packet header format, the data packet being sent from the source node S. In FIG. 11, a data packet header 1110 contains a routing number information 1111 and information 1112 indicating the routing path, in other words a routing list. In FIG. 11, this information 1112 is a list of node identifiers. The data packet in FIG. 11 contains also the payload data 1113.

Each node receiving the data packet decodes the first address of the routing list and compares the decoded address with its own address. If the addresses are identical, the node removes its own address from routing list, reduces the routing number by one and forwards the data packet to next node according to the next address decoded from the routing list. The data packet will finally arrive at the destination node when and only when the routing number is reduced to zero (after reduced by destination) and the first address decoded is the address is the address of the destination node.

Comparing with traditional routing algorithms based on sending HELLO messages, the embodiments of the present invention have the following properties. As the routing is based on location information, regular HELLO messages may be completely omitted and thus the life of a battery of a node can be prolonged. In routing algorithms based on HELLO messages, the basic feature of HELLO messages is to regularly report a node is still alive. Therefore a node has to frequently send HELLO messages, and this consumes power. The battery may be exhausted in a short time. Furthermore, frequent recharging may cause a battery to be broken. Embodiments of the present invention avoid sending HELLO messages.

Using embodiment of the inventions, the maintenance of routing path also becomes easier and faster. Embodiments of the invention may need assistance of a communications network for receiving information about the location of the other node. It is appreciated that thereafter routing discovery and routing may be performed purely in the Ad Hoc network.

Furthermore, a feasible solution for obtaining information about the destination node location over a separate communication system has been proposed. This approach allows each Ad Hoc network node to generate its address/identifier and there is no need for managing the addresses within the Ad Hoc network. This is because information about the destination node address may also be transmitted over the separate communication system. The source node can initiate the route discovery procedure when knowing the destination node location and the destination node identifier/address in the Ad Hoc network. It is evident to one skilled in the art that in generating the Ad Hoc network identifiers/addresses, the probability of two nodes generating a same identifier should be very low.

The reliability of data routing in an Ad Hoc network is also enhanced. Because broadcasting is radiated only when a MN wants to transmit or is transmitting data, so, the value of the timer t₂ can be set comparatively small and thus, the changes of the topology of an Ad Hoc network can be ignored from the differential viewpoint. As this solution completely avoids HELLO messages, it is possible to shorten the timer t₂ without adding much load on the battery. Shortening the timer t₂ will clearly enhance the reliability of communication.

It is also appreciated that implementing embodiment of the present invention does not require large investments.

FIG. 12 shows schematically a block diagram of a node for an Ad Hoc network in accordance with an embodiment of the present invention. The device 1200 contains the necessary functionality 1210 for sending and receiving information to and from similar nodes, a set of similar nodes forming an Ad Hoc network. A similar node here refers to a device containing at least the functionality 1210 and the routing functionality 1220. The routing functionality 1220 is configured to implement an embodiment of the present invention for route discovery and routing in an Ad Hoc network. The routing functionality 1220 is typically implemented as software. The device 1200 typically further contains functionality 1230 for determining geographic location of the device. For implementing some embodiments of the invention, functionality 1240 for communications via a communications network is needed. It is clear to one skilled in the art how the interactions between the blocks 1210, 1220, 1230 and 1240 can be arranged. Also, it is clear that the block 1210, 1230 and 1240 may be conventional equipment. It is possible that the routing functionality 1220 is integrated in the block 1210.

The device 1200 is typically a portable communications device. It may be, for example, user equipment, a mobile telephone, a mobile station, a personal digital assistant, or a laptop computer. The device 1200 may alternatively be a fixed device. As an example, it may be a network element for a communications system capable to act also as a node in an Ad Hoc network.

It is appreciated that although in the specific examples above the routing request comprises information indicating the geographic location of the destination node, the information relating to the destination location may be other information from which the destination node location may be determined. As an example, it is possible that an Ad Hoc network is divided into areas and each area has a specific area identifier. This area identifier may be comprised in a routing request as information relating to the destination node location.

It is furthermore appreciated that the routing response comprises information relating to the (geographic) distance between the sender of the routing response and the destination node location. This information may be, as discussed above, explicitly the distance. Alternatively, the routing response may comprise any other information from which the distance may be determined in the node receiving the routing response.

Although preferred embodiments of the apparatus and method embodying the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. A method for obtaining routing information relating to a routing path from a source node to a destination node among a set of nodes, said method comprising:
sending a routing request from a current node, said routing request comprising information relating to a destination node location;
receiving at least one routing response in the current node, a routing response comprising information relating to a distance between a sender of the at least one routing response and the destination node; and
selecting, in the current node, a next node along a routing path based at least on said distance between a sender of the at least one routing response and the destination node.

2. A method as defined in claim 1, wherein in the step of selecting the next node along the routing path, the sender of the at least one routing response having a smallest distance to the destination node location is selected as the next node.

3. A method as defined in claim 2, wherein said at least one routing response comprises information indicating a velocity of the sender of the at least one routing response.

4. A method as defined in claim 3, wherein in the step of selecting the next node along the routing path, the sender of the at least one routing response having the smallest distance to the destination node location and having a velocity below a velocity threshold is selected as the next node.

5. A method as defined in claim 1, comprising sending information indicating the next node along the routing path from the current node to the next node.

6. A method as defined in claim 5, wherein in the step of sending information indicating the next node along the routing path, said information indicating the next node indicates the routing path from the source node to the current node.

7. A method as defined in claim 6, wherein said information indicating the next node comprises a plurality of node identifiers.

8. A method as defined in claim 1, comprising sending a further routing request from the next node, after carrying out said selecting the next node step, said further routing request comprising information relating to said destination node location.

9. A method as defined in claim 1, comprising receiving information indicating that the sender of the information is the destination node.

10. A method as defined in claim 9, comprising sending to the destination node information indicating the routing path from the source node to the destination node.

11. A method as defined in claim 1, further comprising:
receiving information indicating the routing path from the source node to the destination node; and
forwarding said information indicating the routing path to a previous node in the routing path.

12. A method as defined in claim 1, comprising determining a location of the current node.

13. A method as defined in claim 12, wherein the location of the current node is determined using signals received by the current node from at least one of the following: a satellite positioning system and a fixed communications system.

14. A method as defined in claim 1, comprising determining an identifier for the current node in the current node for identifying the current node among said set of nodes.

15. A method as defined in claim 14, wherein in said determining an identifier step, said identifier provides identity privacy for the current node.

16. A method as defined in claim 14, wherein in said determining an identifier step, said identifier is determined randomly.

17. A method as defined in claim 1, wherein in said receiving at least one routing response step, said information relating to the distance comprises at least one of following: information indicating the distance and information from which the distance can be determined.

18. A method as defined in claim 1, wherein in said sending a routing request step, said at least one routing request comprises information indicating an identifier of the destination node.

19. A method as defined in claim 1, wherein the current node is the source node, the method comprising determining an identifier of a destination node and a destination node location.

20. A method as defined in claim 19, comprising communicating with the destination node via a communications system.

21. A method as defined in claim 20, wherein the step of communicating with the destination node via the communications system comprises receiving information indicating the destination node location from the destination node.

22. A method as defined in claim 20, wherein the step of communicating with the destination node comprises receiving information indicating an identifier of the destination node.

23. A method for obtaining routing information relating to a routing path from a source node to a destination node among a set of nodes, comprising:
receiving a routing request in a current node from a previous node, said routing request comprising information relating to a destination node location; and
sending a routing response, in response to receiving the routing request, to the previous node for selecting a next node along the routing path in the previous node, said routing response comprising information relating to a distance between the current node and the destination node location.

24. A method as defined in claim 23, further comprising:
receiving information indicating that the current node is a next node along the routing path; and
in response to receiving said information indicating that the current node is a next node along the routing path, sending from the current node a further routing request, said further routing request comprising information relating to the destination node location.

25. A method as defined in claim 24, further comprising:
receiving at least one further routing response in the current node, the at least one further routing response comprising information relating to a distance between a sender of the respective at least one further routing response and the destination node; and
selecting a next node along the routing path based at least on said distance between the sender of the at least one routing response and the destination node.

26. A method as defined in claim 25, wherein in the step of selecting the next node along the routing path, the sender of the at least one further routing response having a smallest distance to the destination node location is selected as the next node.

27. A method as defined in claim 23, comprising sending information indicating the next node along the routing path from the current node to the next node.

28. A method as defined in claim 23, comprising receiving information indicating that the sender of the information is the destination node.

29. A method as defined in claim 28, comprising sending to the destination node information indicating the routing path from the source node to the destination node.

30. A method as defined in claim 23, further comprising:
receiving information indicating the routing path from the source node to the destination node; and
forwarding said information indicating the routing path to the previous node in the routing path.

31. A method as defined in claim 23, comprising determining a location of the current node.

32. A method as defined in claim 23, comprising determining an identifier for the current node in the current node for identifying the current node among said set of nodes.

33. A method as defined in claim 23, wherein in said sending a routing response step, said information relating to the distance comprises at least one of following: information indicating the distance and information from which the distance can be determined.

34. A method as defined in claim 23, wherein in said receiving a routing request step, said routing request comprises information indicating an identifier of the destination node.

35. A node for network formed of a set of nodes, the node comprising routing means configured to:
send a routing request comprising information indicating at least an identifier of a destination node and a destination node location;
receive at least one routing response, the at least one routing response comprising information relating to a distance between a sender of the respective at least one routing response and the destination node; and
select a next node along a routing path based at least on said distance between the sender of the at least one routing response and the destination node.

36. A node for network formed of a set of nodes, the node comprising routing means configured to:
receive a routing request comprising information relating to a destination node location; and
send a routing response for selecting a next node along a routing path, said routing response comprising information relating to a distance between the node and the destination node location.

37. A node as defined in claim 36, wherein said routing means are configure to:
receive information indicating that the node is a next node along the routing path; and
in response to receiving said information indicating that the node is a next node along the routing path, send a further routing request, said further routing request comprising information relating to the destination node location.

38. A node as defined in claim 35, comprising means for determining a location of the node.

39. A node as defined in claim 35, comprising means for communicating with the set of nodes via a communications system.

40. A node as defined in claim 39, configured to receive via the communications system information indicating an identifier of the node among said set of nodes.

41. A node as defined in claim 39, configured to receive via the communications system information indicating the location of the node.

42. A node as defined in claim 35, comprising a portable communications device.

43. A node for network formed of a set of nodes, the node comprising:
means for sending a routing request comprising information indicating at least an identifier of a destination node and a destination node location;
means for receiving at least one routing response, the at least one routing response comprising information relating to a distance between a sender of the respective at least one routing response and the destination node; and
means for selecting a next node along a routing path based at least on said distance between the sender of the at least one routing response and the destination node.

44. A node as defined in claim 43, further comprising means for determining a location of the node.

45. A node as defined in claim 43, further comprising means for communicating with the set of nodes via a communications system.

46. A node as defined in claim 45, configured to receive via the communications system information indicating an identifier of the node among said set of nodes.

47. A node as defined in claim 45, configured to receive via the communications system information indicating the location of the node.

48. A node as defined in claim 43, comprising a portable communications device.
